(19) United States
(12) Patent Application Publication
(10) Pub. No.: US 2023/0260495 A1
(43) Pub. Date: Aug. 17, 2023

(54) SOUND INTERLAYER

(71) Applicant: SAINT-GOBAIN GLASS FRANCE, COURBEVOIE (FR)

(72) Inventor: Shuibao QI, COMPIEGNE (FR)

(21) Appl. No.: 18/012,888

(22) PCT Filed: Jun. 28, 2021
(86) PCT No.: PCT/FR2021/051188

§ 371 Date: Dec. 23, 2022

(30) Foreign Application Priority Data
Jun. 30, 2020 (FR) 2006876

(51) Int. Cl. G10K 11/168; G10K 11/172; B32B 17/10; B32B 17/06; B32B 3/10

(52) U.S. Cl. CPC G10K 11/168; G10K 11/172; B32B 17/10036; B32B 17/10614; B32B 17/10761; B32B 17/067; B32B 3/10; B32B 2307/102

(57) ABSTRACT

A sound interlayer includes a first layer made from a first material and a second layer, wherein the second layer comprises a damping system including at least one patch made from a second material different from the first material.

### TECHNICAL FIELD OF THE INVENTION

The present invention relates to solutions for improving materials for the automotive and construction industries.

### TECHNICAL BACKGROUND

In the materials used for the construction and automotive industries, soundproofing is an important aspect as it enables materials to filter external noises in order to provide acoustic comfort. An essential physical parameter to assess the acoustic performance of elastic panels is the sound transmission loss (STL) which becomes an industrial design factor explored and studied in the field of acoustic materials. In low frequency ranges, sound transmission loss (STL) is mainly governed by the mass law. The traditional design concept for low frequencies consists in increasing the acoustic surface mass and finding the compromise between the weight and sound transmission loss (STL) for the lightweight requirements demanded in practice. For medium to high frequency ranges, sound transmission loss (STL) can be markedly degraded by the well-known coincidence effect caused by the interaction of sound waves in the fluid-solid interface. To minimize the effect, visco-elastic materials, such as rubbers, PVB, thin films, etc., have been widely applied and integrated into glass panels to form stratified structures. For frequencies above the coincidence frequencies, the sound transmission loss (STL) is mainly governed by the rigidity of the panels.

It is therefore necessary to find a material which can reduce the sound transmission loss (STL) over the widest band of frequencies possible.

### SUMMARY OF THE INVENTION

One aim of the present invention is to provide a material which can reduce the sound transmission loss (STL) over the widest band of frequencies possible.

To this end, the invention relates to a sound interlayer comprising a first layer made from a first material and a second layer, characterized in that the second layer comprises damping means comprising comprises at least one patch made from a second material different from the first.

According to one example, the first layer comprises a sheet or a set of sheets.

According to one example, said first layer comprises at least one hole enabling said patch to be inserted therein.

According to one example, the hole is a through-hole for a first layer comprising a sheet or a set of sheets, or a blind hole for a first layer comprising a set of sheets.

According to one example, the second layer comprises a plurality of patches, said first layer comprising an equal number of holes to the number of patches so that each patch is inserted into a hole.

According to one example, the patches forming the second layer are connected to each other by fasteners to form a network.

According to one example, the patches are heterogeneous in dimension with a diameter varying from 10 to 50 mm.

According to one example, the patches are separated from each other by a length of 0 to 40 mm.

According to one example, the patches represent at least 30% of the surface of the interlayer.

According to one example, the second material is chosen from the list comprising: metals or one of their alloys or oxides, ceramics, wood-type organic materials, mineral-type materials such as glass, rock.

According to one example, the first material is a polymer-type plastic, preferably a polyvinylbutyral (PVB) or a woven or non-woven fabric based on natural or synthetic fibers such as hemp or flax or a glass fiber-based textile.

The invention further relates to an insulation panel comprising at least a first substrate, characterized in that it further comprises an interlayer according to the invention arranged on said substrate.

According to one example, the panel comprises a second substrate, the first and the second substrate forming said panel.

According to one example, the panel comprises a second substrate, said interlayer being arranged to join the first substrate with the second substrate.

According to one example, each substrate is a glass sheet.

According to one example, each substrate is a plaster or plywood-type panel.

### DESCRIPTION OF THE FIGURES

Other features and advantages will be evident from the following description, which is indicative and not limiting, with reference to the attached drawings, in which:

FIGS. 1 and 2 schematically depict an interlayer according to the invention;

FIG. 3 schematically depicts an interlayer according to the invention wherein the support comprises a set of sheets;

FIG. 4 schematically depicts the various forms of patches of the interlayer according to the invention;

FIG. 5 schematically depicts an interlayer according to the invention equipped with a plurality of patches;

FIG. 6 schematically depicts various arrangements of patches of the interlayer according to the invention;

FIG. 7 depicts a diagram on the performance of various interlayers including the interlayer according to the invention;

FIG. 8 schematically depicts an improved version of the arrangement of patches for the interlayer according to the invention;

FIG. 9 schematically depicts a variant of the patches of the interlayer according to the invention;

FIGS. 10a and 10b schematically depict a variant of the interlayer according to the invention;

FIGS. 11 to 13 schematically depict an insulation panel comprising the interlayer according to the invention;

FIG. 14 schematically depicts a preferred embodiment of the interlayer according to the invention;

FIG. 15 schematically depicts a configuration of the patches with means for engaging the interlayer according to the invention.

### DETAILED DESCRIPTION

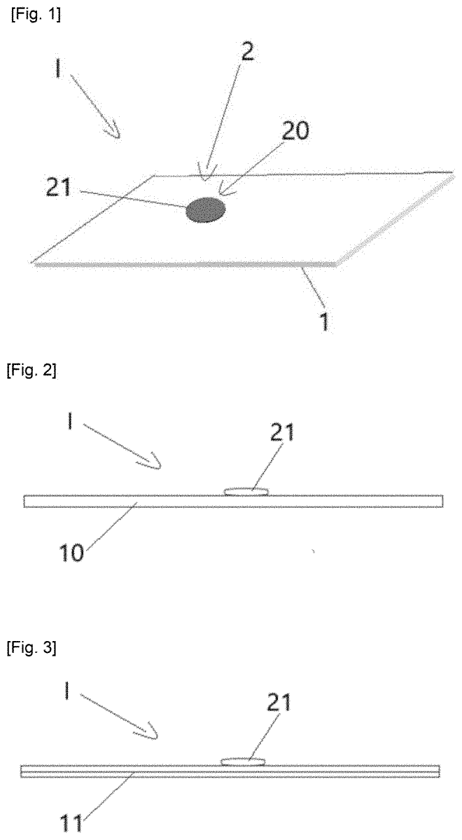

In the example of FIG. 1, the invention is represented. The invention is presented in the form of an interlayer I.

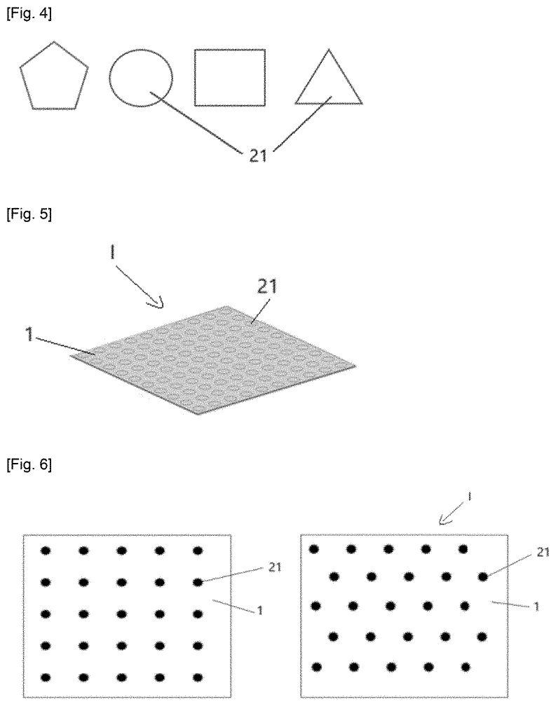

This interlayer comprises a first layer 1. This first layer 1 is presented in the form of a support made from a first material. This support 1 comprises at least one sheet 10 as shown in FIG. 2. This sheet can be replaced by a set of sheets 11 i.e. the support 1 may comprise several sheets assembled together as shown in FIG. 3. This interlayer I is used to be associated with at least one substrate S in order to form an acoustic insulation panel.

The interlayer according to the invention further comprises a second layer 2. This second layer comprises damping means 20. These damping means 20, are means to absorb the noises, comprise at least one patch 21 or mass. This patch 21 is made from a second material. This patch 21 can take a variety of forms and comprises an internal face, an upper face and an edge face. The shape of this patch is circular or oval or square or diamond, rectangle, triangle or any regular shape as shown in FIG. 4. The profile of the patch 21 is flat i.e. the lower face and the upper face are planar.

Alternatively, at least the upper face or even the lower face may be curved, the curvature of the upper face and the curvature of the lower face may or may not be parallel, concave or convex. In the case where the patches present a curvature at the level of the upper face and of the lower face, the curvatures are identical or reversed or different.

This patch 21 is then placed in contact with the support 1 i.e. with the sheet or the set of sheets.

This combination of a support 1 and at least one patch 21 makes it possible to improve the sound performance of this interlayer I.

In fact, the support 1 has mechanical properties notably an elasticity so that the sound waves at a certain band of frequency are absorbed by said support. The first material of the support is a plastic such as a polyvinylbutyral (PVB)-type polymer or a woven or non-woven fabric based on natural or synthetic fibers such as hemp or flex or a glass fiber-based textile.

In addition, the patches 21 also act to improve the sound properties. This mass effect comes from the mass law. Thus, each patch 21 is able to enter into resonance along a dedicated frequency band according to its mass. This entry into resonance is due to the sound vibrations making contact with the patch 21. The second material of the patches is different from the first material of the first layer 1. This second material is selected from the list comprising: metals or one of their alloy or oxide, ceramics, wood-type organic materials, mineral-type materials such as glass, rock.

If the support 1 or the patches 21 each affect the sound performance, the two elements combined also have an effect on the sound performance. This effect is the consequence of a lack of homogeneity between the support and the patches which makes it possible to reduce the coincidence effect and improve the sound insulation performance.

In the case of the support 1, the sheet(s), making it possible to form said support 1, are made from a first material of the polymer or plastic or elastic type.

In the case of a set of sheets, the sheets may be composed of the same material or be composed of a different material in order to have different properties.

The first material therefore has acoustic properties i.e. mechanical properties making it possible to absorb sound vibrations.

In the case of patches 21 or masses being used, several parameters must be taken into account.

In fact, if a patch 21 locally makes it possible to have an effect on the sound performance, for a larger surface area, a single patch is ineffective. For this, it is necessary to use a greater number of patches 21. The patches 21 are distributed over the surface of the support 1 to obtain an effect on the sound performance over the entire surface of the support as shown in FIG. 5.

The positioning of the patches is random or, preferably, regular. This regularity in the positioning of the patches makes it possible to obtain homogeneous acoustic performances over the entire surface of the support.

If the density of patches over a zone A is greater than the density of patches over a zone B then the acoustic performance of zones A and B differ.

The density depends on the number of patches per unit of area and therefore consequently on the dimension of the patches and their spacing.

This density also has a consequence on the weight (kg) of the interlayer so that the higher the density the heavier the interlayer. This heaviness may be disadvantageous when using said interlayer.

Within the scope of the present invention, the spacing between the different patches forming the second layer is between 0.5 and 5 cm, preferably between 1 and 3 cm.

Consequently, the second layer 2 comprises a plurality of patches 21 which are, preferentially, all spaced the same interval apart from each other. This spacing makes it possible to have patches 21 positioned to form a lattice or patches arranged in a staggered manner as shown in FIG. 6.

The density also depends on the dimensions of said patches 21. As a reminder, the shape of this patch is circular or oval or square or diamond, rectangle, triangle or any regular shape. Thus, it will be assumed that the patches have a diameter or a length or a width or a side-length between 5 and 20, preferably between 5 and 10 mm. For example, for a circular patch 21, the diameter will be between 5 and 10 mm whereas for a square patch, the length of the sides is between 5 and 10 mm, which is the same for a triangle or a rectangle or a trapezium.

If the shape and the dimensions of the patches are substantial it is because, due to the mass law, the patches are able to resonate via the sound vibrations, this resonance making it possible to reduce the external noise.

And yet, depending on the shape and the dimensions of the patch, the resonance is not done at the same frequency or at the same frequency bands. A plurality of circular patches with a diameter of 7 mm does not have the same frequency or frequency bands as a plurality of patches with a diameter of 18 mm.

Thus, the patches are arranged to cover at least 30% of the surface of the support, preferably 40%. This minimum value of 30% makes it possible to have a sufficient mass to enable said patches to enter into resonance when sound vibrations reach the interlayer according to the invention.

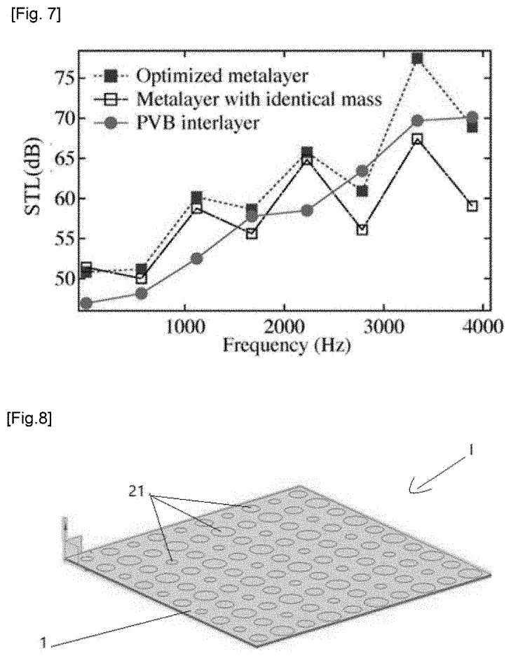

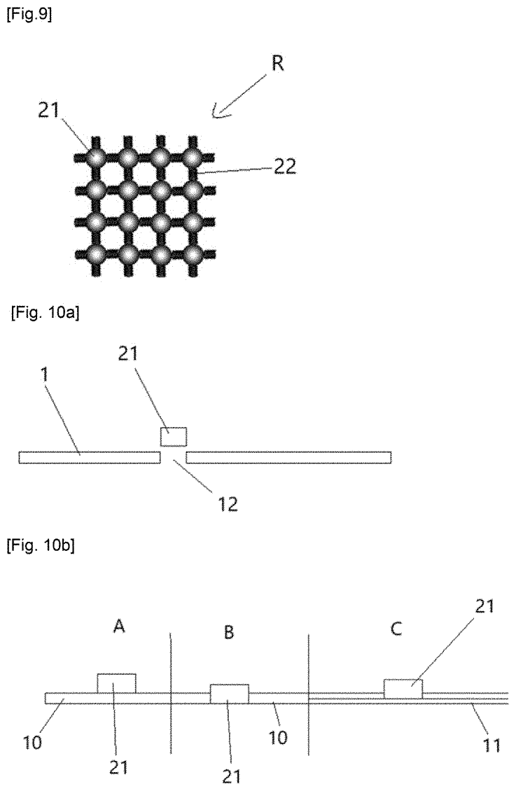

In one variant, the second layer 2 is arranged to enable acoustic filtration within a wider frequency band. For this, several categories of patches are used. Thus, the second layer is formed by a first series of patches having a first shape of a first mass M1, a second series of patches having a second shape and a second mass M2 and so on. In fact, as mentioned previously, the mass law enables the resonance of the patches based on the sound waves. This resonance depends on the mass of said patch 21. Thus, having patches of different shapes and masses to form the second layer, the operating range of the second layer is broadened. In FIG. 7, a diagram representing the level of sound transmission loss as a function of the frequency range is depicted. This diagram shows that an interlayer whose patches 21 are identical is more effective than a conventional polymer interlayer film (herein PVB) from 0 to 1000 Hz and around 2000 Hz but less effective after 2500 Hz. Furthermore, on this diagram in FIG. 7, it can be noted that for an optimized interlayer i.e. with patches 21 of different shapes, the performance level beyond 2500 Hz is better.

These different series of patches 21 of different shapes and masses are thus positioned to be distributed regularly. This distribution (or positioning) is such that the different series are inserted between each other. In fact, to retain uniformity of acoustic performance, the patches 21 are positioned so that the patches 21 of the first series form a regular network, that the patches 21 of the to second series form another regular network, and so on, the various networks being inserted between each other as shown in FIG. 8.

For example, in the case of two networks, one possible arrangement is to have alternating lines made with the patches 21 of the first series and the patches 21 of the second series. Another example consists in, for each line, alternating between one patch 21 of the first series and one patch 21 of the second series. For two adjacent lines, the patches 21 of the first series and the patches 21 of the second series are offset in order to have a staggered shape.

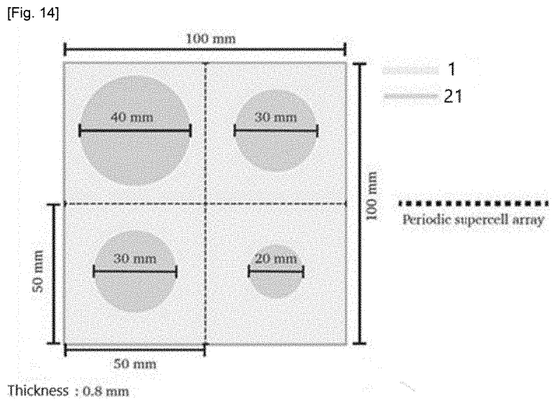

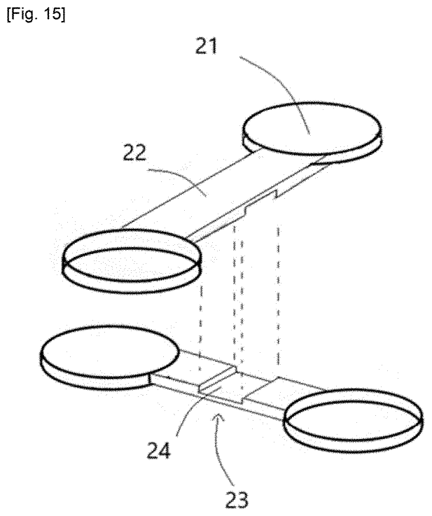

In a preferred embodiment visible in FIG. 14, the patches 21 are arranged in the following shape. The interlayer I is thus divided into a multitude of units, each unit is presented in the form of a square with sides 100 mm in length. The total thickness is 0.8 mm. This square is subdivided into four squares with sides 50 mm in length. These 50 mm-sided squares are named, from left to right and from top to bottom, A, B, C D. Each square with sides 50 mm in length comprises a patch which is centered therein.

According to this preferred embodiment, the patches of different squares are not all identical. More particularly, the unit is such that a first pair of patches positioned diagonally to each other are identical and that the other two patches, forming the second pair, arranged diagonally are different from each other and different from the patches of the first pair. This arrangement thus makes it possible to have a unit, therefore the acoustic performance covers a wide band. In fact, the performance of the patches depends on the mass and therefore on the dimensions.

Preferentially, the patch of square A has a diameter of 35 to 45 mm, preferably 40 mm. The patches of squares B and C have a diameter of 25 to 35 mm, preferably 30 mm. The patch of square D has a diameter of 15 to 25 mm, preferably 20 mm.

In a further preferred embodiment, the patch of square A weighs 2.5 grams, the patches of squares B and C weigh 1.4 grams and the patch of square D weighs 0.6 g.

This configuration enables a gain in terms of the sound transmission loss (STL) of 3 to 4 dB. In an alternative embodiment, the patches 21 of one series are attached to each other. This attachment of patches 21 is achieved by fasteners 22 between each patch 21. These fasteners are, preferentially, made from the same material as the patches 21 so that the patches and the fasteners 22 are a single unit. Thus the fasteners and the patches are such as the patches positioned to form the desired network.

In the case of several series of patches, each series of patches is presented in the form of a network R wherein the patches 21 are attached as shown in FIG. 9.

The arrangement of the various series with each other is performed by stacking them one on top of each other. To secure the networks R of patches therebetween, the latter can be bonded or fastened mechanically by clips. Another mounting solution consists in inserting the networks of patches 21 between two sheets 10 or sets 11 forming the support.

In a second variant, the interlayer I is arranged to be more compact. In fact, if the acoustic performance is significant, it is also desirable that the interlayer according to the invention is also the least restrictive. One constraint which may appear is that of the thickness which increase which impair the compactness of the acoustic insulation panel.

In order to limit the thickness of said interlayer, it is cleverly intended that the support 1 is locally perforated as shown in FIGS. 10a and 10b. This local perforation consists in locally making at least one hole 12 on the support. This hole 12 is a through-hole or a blind hole. The hole 12 is a through-hole when the support comprises a single sheet or a set of sheets. The hole is a blind hole in the case of a support 1 comprising a set of sheets 11. In this case, the hole 12 consists in cutting and removing layers, each layer being one of the sheets of the set 11. Ideally the number of holes 12 is equal to the number of patches 21.

These holes 12 are sized so that the patches 21 forming the second layer 2 are inserted therein. This insertion of patches makes it possible to limit the local thickness. Indeed, the total thickness of the interlayer I is the sum of the thickness of the support 1 and of the thickness of the patches 21 (zone A), the thickness of the thickest patches 21 in the case of different series of patches 21 which do not necessarily have the same thickness. And yet, this variant cleverly makes it possible not to, locally, build up the thickness of the patches 21, for the thickest in the case of several series of patches 21, and the entire thickness of the support 1, in particular in the case of a set of sheets 11. The total thickness of the interlayer is therefore reduced, by the total thickness of the support (zone B) or by the thickness of at least one sheet of the set (zone C).

In the case of patches 21 which are attached to each other in order to form a network, several configurations are possible.

In a first configuration of a single network wherein the fasteners have the same thickness as the patches, the support 10 is perforated across the entire surface of said network i.e. at the level of the patches 21 and fasteners 22.

In a second configuration of a single network wherein the fasteners 22 have a different thickness to that of the patches 21, the support 1 is perforated over the surface of said network at the level of the patches 21 or fasteners 22 depending on whether the patches are thicker than the fasteners or vice versa.

In a third configuration wherein at least two series of attached patches 21 having a network shape are present, one series is in contact with the support. The support is then perforated as a function of the thickness of this series.

In a fourth configuration wherein at least two series of attached patches 21 having a network shape are present, the thickness is reduced by engagement means 23 as shown in FIG. 15. In this fourth configuration, the patches 21 of the two networks are arranged to form a mesh, the patches of the second network being arranged in order to be staggered with respect to the patches of the first series. In this case, the fasteners 22 of the first series and the fasteners 22 of the second series overlap so that a fastener of the first series and a fastener of the second series, one above the other, form a cross.

In this case, the engagement means consist of a plurality of notches 24 arranged on the fasteners of at least the first series or the second series. These notches are, in particular, arranged on the faces of the fasteners of the first series or of the second series facing the fasteners of the other series. Thus, notches 24 arranged on the fasteners of the first series enable the fasteners of the second series to be inserted therein. In the case where the notches are adjusted in relation to each other, the insertion is performed with force and requires a highly elastic fastener material. In the case where the notches are not adjusted in relation to each other, i.e. there is play between the two, then the insertion is performed just by placing one network on the other, without force. Preferentially, the notches are arranged on the fasteners of the two series.

These notches result in a reduction in the thickness of the two series assembled to one another.

In the case of a number of series greater than two, the first series only comprises notches on the face of the fasteners facing the second series. The following series may comprise notches only on the face of the fasteners facing the next series. It is thus understood that the fasteners of the second series comprise notches on the face facing the third series and so on. However, it is possible that the series after the first series are equipped with notches on each face of the fasteners facing another series.

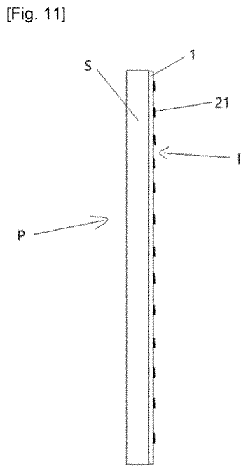

This interlayer is then used to be associated with at least one substrate S in order to form an acoustic insulation panel P as shown in FIG. 11.

According to a first embodiment, the interlayer according to the invention is used for a glazing application. Thus, the first material of the first layer 1 and the second material of the second layer 2 are, preferably, transparent. The acoustic insulation panel comprises at least one glass sheet used as substrate.

In a first configuration, the interlayer is associated with a single glass sheet. The interlayer is fixed to the substrate by known mounting means of a polymer film on a glass sheet.

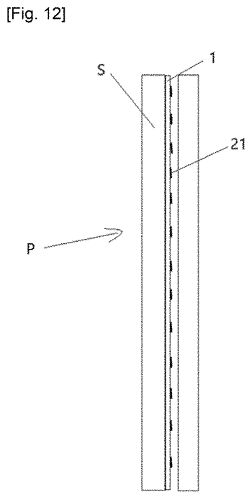

This glass sheet is used alone as an acoustic insulation panel or it is used with a second glass sheet. These two glass sheets, one of which comprises the interlayer, are combined in a frame so that an air gap is present between the two sheets as shown in FIG. 12. This combination is used to create a so-called double glazing.

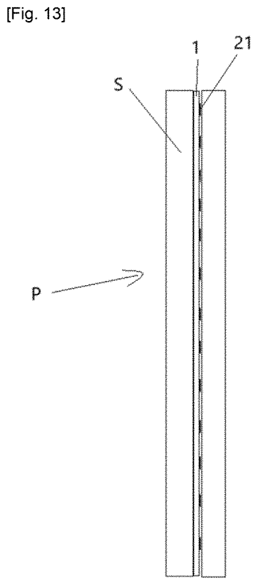

In a second configuration, the acoustic insulation panel comprises a first glass sheet and a second glass sheet. The interlayer according to the invention is then used to secure the two glass sheets therebetween. A laminated glazing is therefore created as shown in FIG. 13.

In this first embodiment, it is important to check the thickness.

In a second embodiment, the insulation panel may be used in the construction industry for the sound insulation of wall panels, floors and other surfaces. The substrate used is a plaster or plywood-type panel whose thickness is at least 10 mm. The insulation panel comprises at least one panel on which said interlayer according to the invention is placed. This interlayer may be placed between two panels.

Of course, the present invention is not limited to the illustrated example but is susceptible to various variants and modifications which will become apparent to the person skilled in the art.

1. A sound interlayer comprising a first layer made from a first material and a second layer,
wherein the second layer comprises a damping system comprising at least one patch made from a second material different from the first material.

2. The interlayer according to claim 1, wherein the first layer comprises a sheet or a set of sheets.

3. The interlayer according to claim 2, wherein said first layer comprises at least one hole enabling said at least one patch to be inserted therein.

4. The interlayer according to claim 3, wherein the at least one hole is a through-hole for a first layer comprising a sheet or a set of sheets, or a blind hole for a first layer comprising a set of sheets.

5. The interlayer according to claim 3, wherein the second layer comprises a plurality of patches, said first layer comprising an equal number of holes to the number of patches so that each patch is inserted in a hole.

6. The interlayer according to claim 5, wherein the plurality of patches forming the second layer are connected to each other by fasteners to form a network.

7. The interlayer according to claim 1, wherein the plurality of patches are heterogeneous in dimension with a diameter varying from 10 to 50 mm.

8. The interlayer according to claim 5, wherein the plurality of patches are separated from each other by a length of 0 to 40 mm.

9. The interlayer according to claim 5, wherein the plurality of patches represent at least 30% of a surface of the interlayer.

10. The interlayer according to claim 1, wherein the second material is chosen from the list comprising: metals or one of their alloy or oxide, ceramics, wood-type organic materials, mineral materials.

11. The interlayer according to claim 1, wherein the first material is a polymer plastic or a woven or non-woven fabric based on natural or synthetic fibers or a glass fiber-based textile.

12. An insulation panel comprising at least a first substrate, and an interlayer according to claim 1 arranged on said first substrate.

13. The insulation panel according to claim 12, comprising a second substrate, the first and the second substrate forming said insulation panel.

14. The insulation panel according to claim 13, comprising a second substrate, said interlayer being arranged to secure the first substrate with the second substrate.

15. The insulation panel according to claim 12, wherein each substrate of the insulation panel is a glass sheet.

16. The insulation panel according to claim 12, wherein each substrate of the insulation panel is a plaster or plywood-type panel.

17. The interlayer according to claim 10, wherein the mineral materials include glass or rock.

18. The interlayer according to claim 11, wherein the first material is polyvinylbutyral (PVB) and the the natural or synthetic fibers include hemp or flax.
